(19) United States
(12) Patent Application Publication
(10) Pub. No.: US 2022/0166234 A1
(43) Pub. Date: May 26, 2022

(54) PROTECTIVE CIRCUIT, ENERGY STORAGE APPARATUS, AND CONTROL METHOD FOR PROTECTIVE CIRCUIT

(71) Applicant: GS Yuasa International Ltd., Kyoto-shi (JP)

(72) Inventors: Shigeki HATTORI, Kyoto-shi, Kyoto (JP); Masakatsu FUJIMATSU, Kyoto-shi (JP)

(21) Appl. No.: 17/441,164

(22) PCT Filed: Mar. 18, 2020
(86) PCT No.: PCT/JP2020/012060

§ 371 Date: Sep. 20, 2021

(30) Foreign Application Priority Data
Mar. 26, 2019 (JP) 2019-058036

(51) Int. Cl. H02J 7/00

(52) U.S. Cl. CPC H02J 7/0032; H02J 7/0063; H02J 7/00306; H02J 7/00302; H02J 7/00304

(57) ABSTRACT

A protective circuit for an energy storage device includes: a cutoff switch that cuts off a current of the energy storage device; a drive circuit that drives the cutoff switch; a power source switch provided on a power source line of the drive circuit; and a control unit, in which the control unit switches a control terminal of the cutoff switch from a high potential to a low potential, and then turns off the power source switch.

### TECHNICAL FIELD

The present invention relates to a protective circuit for an energy storage device, an energy storage apparatus, and a control method for the protective circuit.

### BACKGROUND ART

An energy storage apparatus includes a cutoff switch, and when an abnormality occurs, a current is cut off to protect an energy storage device in the energy storage apparatus. Patent Document 1 below discloses that a semiconductor switch such as an FET is used as the cutoff switch.

### PRIOR ART DOCUMENT

### Patent Document

Patent Document 1: JP-A-2003-169422

### SUMMARY OF THE INVENTION

### Problems to be Solved by the Invention

An object of the present invention is to suppress power consumption while maintaining responsiveness of a cutoff switch that cuts off a current of an energy storage device.

### Means for Solving the Problems

According to one aspect of the present invention, there is provided a protective circuit for an energy storage device, including: a cutoff switch that cuts off a current of the energy storage device; a drive circuit that drives the cutoff switch; a power source switch provided on a power source line of the drive circuit; and a control unit, in which the control unit switches a control terminal of the cutoff switch from a high potential to a low potential, and then turns off the power source switch.

The present technology can be applied to an energy storage apparatus. The present technology can also be applied to a control method for a protective circuit, a control program for a protective circuit, and a recording medium that stores the control program for a protective circuit.

### Advantages of the Invention

According to the above configuration, it is possible to suppress the power consumption while maintaining the responsiveness of the cutoff switch.

### BRIEF DESCRIPTION OF THE DRAWINGS

FIG. 1 is an exploded perspective view of a battery.

FIG. 2 is a plan view of a secondary battery.

FIG. 3 is a sectional view taken along the line A-A of FIG. 2.

FIG. 4 is a side view of a motorcycle.

FIG. 5 is a block diagram of the battery.

FIG. 6 is a circuit diagram of a first drive circuit and a second drive circuit.

FIG. 7 is an enlarged view of a first conversion circuit.

FIG. 8 is an explanatory diagram of an operation of the circuit.

FIG. 9 is a flowchart of an off process.

FIG. 10 is an explanatory diagram of an operation of the circuit.

FIG. 11 is an explanatory diagram of an operation of the circuit.

FIG. 12 is a circuit diagram of a first drive circuit.

FIG. 13 is a block diagram of a battery.

### MODE FOR CARRYING OUT THE INVENTION

A protective circuit for an energy storage device includes: a cutoff switch that cuts off a current of the energy storage device; a drive circuit that drives the cutoff switch; a power source switch provided on a power source line of the drive circuit; and a control unit, in which the control unit switches a control terminal of the cutoff switch from a high potential to a low potential, and then turns off the power source switch. According to this configuration, it is possible to suppress power consumption while maintaining responsiveness of the cutoff switch. By quickly switching on and off the cutoff switch, it is possible to suppress damage to the cutoff switch due to a large current flowing in a transient state between on and off of the cutoff switch.

The drive circuit may include a pull-up resistor that connects the control terminal of the cutoff switch to a high potential portion, and a pull-down switch that connects the control terminal of the cutoff switch to a low potential portion. When the pull-down switch is turned off, the control terminal of the cutoff switch is connected to the high potential portion by the pull-up resistor. When the pull-down switch is turned on, the control terminal of the cutoff switch is connected to the low potential portion. By switching the pull-down switch, on and off of the cutoff switch can be controlled. Typically, the cutoff switch is normally turned on, and when an abnormality occurs in the energy storage device, the cutoff switch is turned off to cut off a current. For example, when an overcurrent flows in the energy storage device due to an event such as an external short circuit, the energy storage device can be protected by quickly turning off the cutoff switch that has been turned on by switching the pull-down switch. By quickly turning off the cutoff switch by switching the pull-down switch, it is possible to suppress damage to the cutoff switch due to a large current flowing in a transient state between on and off of the cutoff switch.

By providing the pull-down switch, when the control terminal of the cutoff switch is switched from a high potential to a low potential, charges can be extracted from the control terminal and flow to the low potential portion, so that the responsiveness of the cutoff switch can be improved. By improving the responsiveness of the cutoff switch, it is possible to quickly cut off an overcurrent and quickly receive charge.

When the pull-down switch is turned on, an current flows through the power source line to the pull-up resistor, and the drive circuit consumes power. After a gate of the cutoff switch is switched from a high potential to a low potential, the current of the drive circuit can be cut off by turning off the power source switch. Therefore, the power consumption can be suppressed.

An energy storage apparatus may include: the energy storage device; and the protective circuit, and the drive circuit may use the energy storage device as a power source. The power consumption of the energy storage device can be suppressed by the current cutoff by the power source switch provided in the power source line of the drive circuit.

The energy storage apparatus may further include: a first external terminal connected to a positive electrode of the energy storage device; and a second external terminal connected to a negative electrode of the energy storage device, in which the cutoff switch may include at least a first cutoff switch that cuts off charge to the energy storage device, in which the drive circuit may include at least a first drive circuit that is connected to a first power source line including a first power source switch and drives the first cutoff switch, in which the first cutoff switch may be an N-channel FET having a source connected to the second external terminal and a drain connected to a negative electrode of the energy storage device, in which the first drive circuit may include: a first pull-up resistor that connects a gate of the first cutoff switch to the first power source line; a first pull-down switch that connects the gate of the first cutoff switch to the second external terminal; and a first conversion circuit that converts a reference potential of a control signal output from the control unit from a signal ground of the protective circuit to a potential of the second external terminal and outputs the converted signal to the first pull-down switch, and in which the first conversion circuit may include a conduction cutoff element that cuts off conduction of the gate of the first cutoff switch to the signal ground of the protective circuit when the first power source switch is turned off.

The control signal output from the management unit can be converted from a signal having the signal ground as a reference potential to a signal having the potential of the second external terminal as a reference potential by the first conversion circuit and output to the first pull-down switch. When the first pull-down switch is switched from on to off, the gate of the first cutoff switch is switched from a high potential to a low potential, so that the first cutoff switch can be turned off. When the first power source switch is turned off in order to suppress the power consumption when the first cutoff switch is turned off, the gate of the first cutoff switch is conducted to the signal ground of the protective circuit via the first pull-up resistor and the first drive circuit. Since the source of the first cutoff switch is connected to the second external terminal, a potential difference is generated between the gate and the source, and the first cutoff switch may erroneously operate. By providing the conduction cutoff element, it is possible to prevent the gate of the first cutoff switch from being conducted to the signal ground of the protective circuit, and thus, it is possible to suppress malfunction of the first cutoff switch.

The first conversion circuit may include: an N-channel first FET having a source connected to the signal ground of the protective circuit, a drain connected to the first power source line via a resistor, and a gate connected to the control unit; and a P-channel second FET having a source connected to the first power source line, a drain connected to the second external terminal via a resistor, and a gate connected to a drain of the first FET, and the conduction cutoff element may be a reverse diode in a direction opposite to a parasitic diode of the first FET.

Since the first FET is connected to the signal ground of the protective circuit, even when the first FET is turned off, the gate of the first cutoff switch is conducted to the signal ground of the protective circuit via the parasitic diode. By providing the diode in the direction opposite to the parasitic diode of the first FET, it is possible to suppress conduction of the gate of the first cutoff switch to the signal ground of the protective circuit.

The first drive circuit may include a conduction circuit that conducts the gate of the first cutoff switch to the second external terminal. Since the generation of a potential difference between the gate and the source of the first cutoff switch can be suppressed, the malfunction of the first cutoff switch can be suppressed.

### First Embodiment

1. Description of Structure of Battery 50

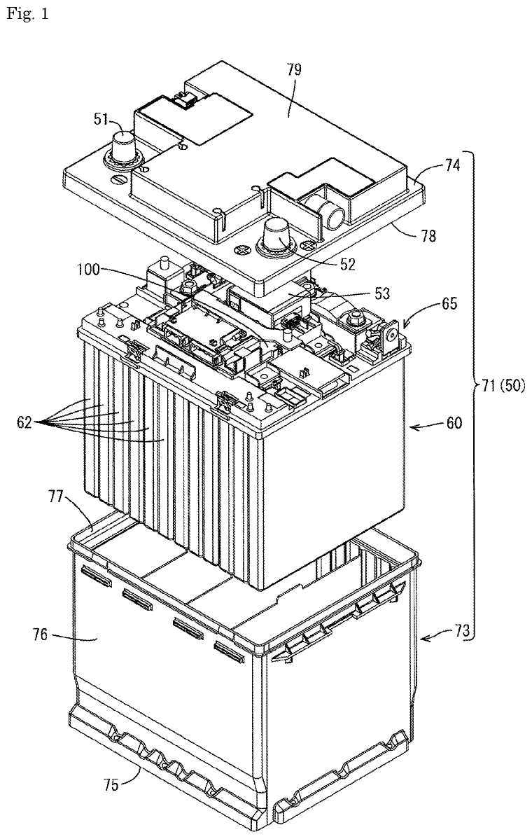

As illustrated in FIG. 1, a battery 50 includes an assembled battery 60, a circuit board unit 65, and a housing 71.

The housing 71 includes a main body 73 made of a synthetic resin material and a lid body 74. The main body 73 has a bottomed cylindrical shape. The main body 73 includes a bottom surface portion 75 and four side surface portions 76. An upper opening 77 is formed at the upper end portion by the four side surface portions 76.

The housing 71 houses the assembled battery 60 and the circuit board unit 65. The assembled battery 60 includes twelve secondary batteries 62. The twelve secondary batteries 62 are connected in three parallel and four series. The circuit board unit 65 includes a circuit board 100 and electronic components mounted on the circuit board 100, and is disposed above the assembled battery 60.

The lid body 74 closes the upper opening 77 of the main body 73. An outer peripheral wall 78 is provided around the lid body 74. The lid body 74 has a protrusion 79 having a substantially T-shape in plan view. A first external terminal 51 of the positive electrode is fixed to one corner portion of the front portion of the lid body 74, and a second external terminal 52 of the negative electrode is fixed to the other corner portion.

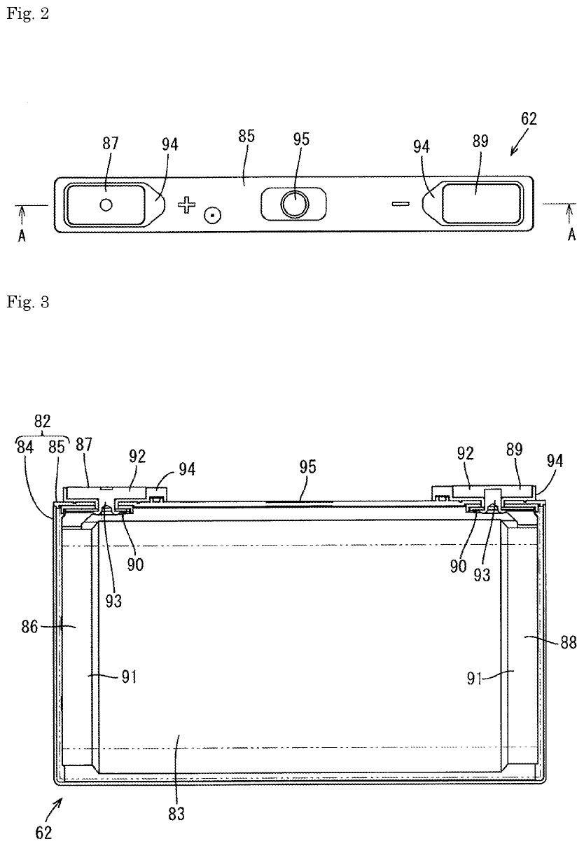

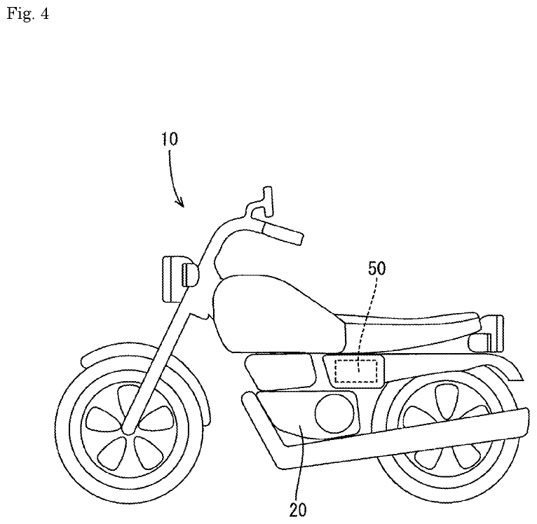

As illustrated in FIGS. 2 and 3, in the secondary battery 62, an electrode assembly 83 is housed in a rectangular parallelepiped case 82 together with a nonaqueous electrolyte. The secondary battery 62 is, for example, a lithium ion secondary battery. The case 82 includes a case body 84 and a lid 85 that closes an opening portion above the case body.

Although not illustrated in detail, the electrode assembly 83 is formed by disposing a separator formed of a porous resin film between a negative electrode element formed by applying an active material to a substrate formed of a copper foil and a positive electrode element formed by applying an active material to a substrate formed of an aluminum foil. The negative electrode element, the positive electrode element, and the separator all have a band shape and are wound in a flat shape so as to be housed in the case body 84 in a state where the negative electrode element and the positive electrode element are displaced to opposite sides in the width direction with respect to the separator.

A positive electrode terminal 87 is connected to the positive electrode element via a positive electrode current collector 86, and a negative electrode terminal 89 is connected to the negative electrode element via a negative electrode current collector 88. Each of the positive electrode current collector 86 and the negative electrode current collector 88 includes a flat plate-shaped pedestal portion 90 and a leg portion 91 extending from the pedestal portion 90. A through hole is formed in the pedestal portion 90. The leg portion 91 is connected to the positive electrode element or the negative electrode element. Each of the positive electrode terminal 87 and the negative electrode terminal 89 includes a terminal body portion 92 and a shaft portion 93 protruding downward from a center portion of a lower surface of the terminal body portion 92. The terminal body portion 92 and the shaft portion 93 of the positive electrode terminal 87 are integrally formed of aluminum (single material). In the negative electrode terminal 89, the terminal body portion 92 is made of aluminum, and the shaft portion 93 is made of copper, and these are assembled. The terminal body portions 92 of the positive electrode terminal 87 and the negative electrode terminal 89 are disposed at both end portions of the lid 85 via gaskets 94 made of an insulating material, and are exposed outward from the gaskets 94.

The lid 85 includes a pressure release valve 95. As illustrated in FIG. 2, the pressure release valve 95 is located between the positive electrode terminal 87 and the negative electrode terminal 89. When the internal pressure of the case 82 exceeds the limit value, the pressure release valve 95 is released to lower the internal pressure of the case 82.

The secondary battery 62 is not limited to a prismatic cell, and may be a so-called pouch cell. The electrode assembly 83 is not limited to a wound type, and may be a laminated type.

As illustrated in FIG. 4, the battery 50 can be used by being mounted on a motorcycle 10. The battery 50 may be for starting the engine 20 which is a driving device of the motorcycle 10. The battery 50 mounted on the motorcycle 10 is limited in size, and the capacity of the built-in secondary battery is smaller than that of the battery mounted on an automobile. A battery management system as a protective circuit receives power supply from a secondary battery, but the battery management system in the motorcycle is required to suppress power consumption as much as possible.

2. Electrical Configuration of Battery 50

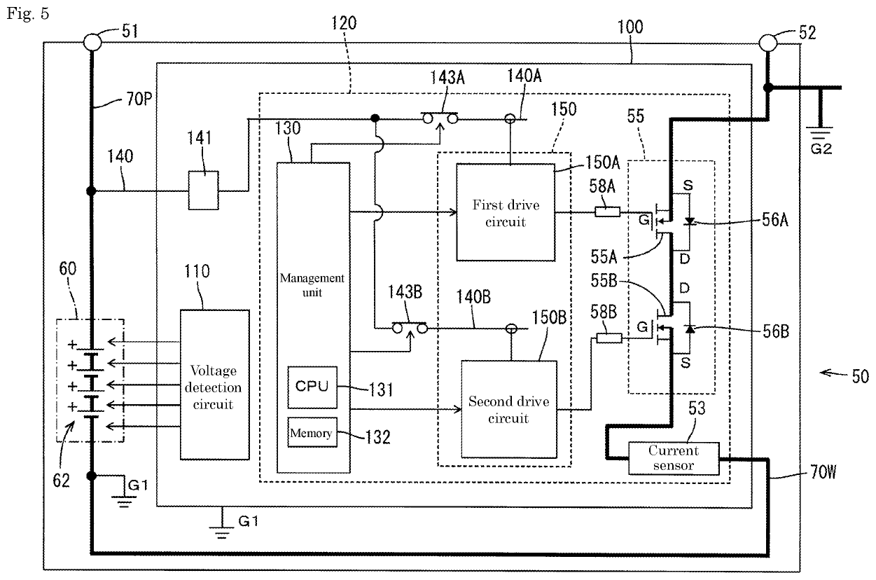

FIG. 5 is a block diagram of the battery 50. The battery 50 includes the assembled battery 60, a current sensor 53, a cutoff switch 55, a voltage detection circuit 110, a management unit 130, and a temperature sensor that detects the temperature of the assembled battery 60.

The assembled battery 60 includes the plurality of secondary batteries 62. There are twelve secondary batteries 62 connected in three parallel and four series. In FIG. 5, three secondary batteries 62 connected in parallel are represented by one battery symbol. The secondary battery 62 is an example of an “energy storage device”. The battery 50 may be rated at 12 V.

The assembled battery 60, the current sensor 53, and the cutoff switch 55 are connected in series via a power line 70P and a power line 70N. The power line 70P and the power line 70N are examples of current paths.

The power line 70P is a power line that connects the first external terminal 51 and the positive electrode of the assembled battery 60. The power line 70N is a power line that connects the second external terminal 52 and the negative electrode of the assembled battery 60. The second external terminal 52 is connected to a body ground G2. The body ground G2 may be a body of the motorcycle 10. The body ground G2 may be a reference potential of the motorcycle 10.

The current sensor 53 is provided in the power line 70N of the negative electrode so as to be connected to the negative electrode of the assembled battery 60. The current sensor 53 can measure a current I of the assembled battery 60.

The voltage detection circuit 110 can detect voltages V of the four secondary battery 62, secondary battery 62, secondary battery 62, and secondary battery 62, and a total voltage of the assembled battery 60. The total voltage of the assembled battery 60 is the total of the voltages of the four secondary batteries.

The management unit 130 includes a CPU 131 and a memory 133. The management unit 130 performs a monitoring process of the battery 50 based on outputs of the voltage detection circuit 110, the current sensor 53, and the temperature sensor. The management unit 130 is an example of a control unit.

The cutoff switch 55 is provided in the power line 70N of the negative electrode so as to be connected to the negative electrode of the assembled battery 60. The cutoff switch 55 includes a first cutoff switch 55A and a second cutoff switch 55B. The first cutoff switch 55A and the second cutoff switch 55B are semiconductor switches for power. The first cutoff switch 55A and the second cutoff switch 55B are N-channel field effect transistors. Sources S of the first cutoff switch 55A and the second cutoff switch 55B are reference terminals. Gates G of the first cutoff switch 55A and the second cutoff switch 55B are control terminals. Drains D of the first cutoff switch 55A and the second cutoff switch 55B are connection terminals.

The source of the first cutoff switch 55A is connected to the second external terminal 52, and the source S of the second cutoff switch 55B is connected to the negative electrode of the assembled battery 60. The drain of the first cutoff switch 55A and the drain of the second cutoff switch 55B are connected. In this manner, the first cutoff switch 55A and the second cutoff switch 55B are connected back-to-back. The back-to-back connection means that two FETs are connected with their backs to each other, that is, drains of the two FETs are connected to each other or sources are connected to each other.

The first cutoff switch 55A incorporates a parasitic diode 56A, and the second cutoff switch 55B incorporates a parasitic diode 56B. The forward direction of the parasitic diode 56A is the same as the discharge direction. The forward direction of the parasitic diode 56B is the same as the charge direction.

Since the source S of the first cutoff switch 55A is connected to the second external terminal 52, the body ground B2 is a reference potential. The source S of the second cutoff switch 55B is connected to the negative electrode of the assembled battery 60. The negative electrode of the assembled battery 60 is connected to a signal ground G1 of the circuit board 100, and a reference potential of the second cutoff switch 55B is the signal ground G1.

The first cutoff switch 55A is turned on by applying an H level voltage to the gate G, and is turned off by applying an L level voltage to the gate G. The same applies to the second cutoff switch 55B. The H level is a high potential, and the L level is a low potential.

The battery 50 includes a drive circuit 150 that drives the cutoff switch 55. The drive circuit 150 includes a first drive circuit 150A that drives the first cutoff switch 55A and a second drive circuit 150B that drives the second cutoff switch 55B.

The first drive circuit 150A is connected to the gate G of the first cutoff switch 55A via a gate resistor 58A. The second drive circuit 150B is connected to the gate G of the second cutoff switch 55B via a gate resistor 58B.

A branch line 140 is connected to the power line 70P of the positive electrode. The branch line 140 branches into a first internal power source line 140A and a second internal power source line 140B.

The first internal power source line 140A is a power source line for the first drive circuit 150A, and the second internal power source line 140B is a power source line of the second drive circuit 150B. The branch line 140 is provided with a regulator 141. The regulator 141 steps down the total voltage of the assembled battery 60 to operating voltages of the first drive circuit 150A and the second drive circuit 150B.

The first internal power source line 140A is provided with a first power source switch 143A, and the second internal power source line 140B is provided with a second power source switch 143B. The management unit 130 controls the first power source switch 143A and the second power source switch 143B to be turned on, for example, in a normal state (when there is no abnormality in the battery).

In a normal state, the management unit 130 applies an H level voltage to the gate G via the first drive circuit 150A, and controls the first cutoff switch 55A to be turned on. In addition, the management unit 130 applies an H level voltage to the gate via the second drive circuit 150B, and controls the second cutoff switch 55B to be turned on.

When both the first cutoff switch 55A and the second cutoff switch 55B are turned on, the assembled battery 60 can be charged and discharged.

When an abnormality of the battery 50 is detected, the management unit 130 controls charge-discharge by switching on and off of the first cutoff switch 55A and the second cutoff switch 55B.

When an overcurrent is detected, the management unit 130 turns off the first cutoff switch 55A via the first drive circuit 150A and turns off the second cutoff switch 55B via the second drive circuit 150B. By turning off the first cutoff switch 55A and the second cutoff switch 55B, the overcurrent can be cut off.

When an overcharge is detected, the management unit 130 turns off the first cutoff switch 55A via the first drive circuit 150A and turns on the second cutoff switch 55B via the second drive circuit 150B. By turning off the first cutoff switch 55A and turning on the second cutoff switch 55B, it is possible to cut off charge and perform only discharge. In this case, the discharge current flows in a current path of the parasitic diode 56A of the first cutoff switch 55A and a drain-source of the second cutoff switch 55B. The first cutoff switch 55A has no discharge-cutoff function, and is a switch that cuts off the charge of the battery 50.

When an overdischarge is detected, the management unit 130 turns on the first cutoff switch 55A via the first drive circuit 150A and turns off the second cutoff switch 55B via the second drive circuit 150B. By turning on the first cutoff switch 55A and turning off the second cutoff switch 55B, it is possible to cut off discharge, and receive only charge. In this case, the charge current flows in a current path of a drain-source of the first cutoff switch 55A and the parasitic diode 56B of the second cutoff switch 55B. The second cutoff switch 55B has no charge-cutoff function, and cuts off the discharge of the battery 50.

The cutoff switch 55, the management unit 130, the first drive circuit 150A, and the second drive circuit 150B are a protective circuit 120 that protects the assembled battery 60. The protective circuit 120 is mounted on the circuit board 100. The protective circuit 120 has the signal ground G1 of the circuit board 100 as a reference potential (operation reference). The negative electrode of the assembled battery 60 is also connected to the signal ground G1, and the assembled battery 60 has the signal ground G1 as a reference potential.

3. Description of First Drive Circuit and Second Drive Circuit

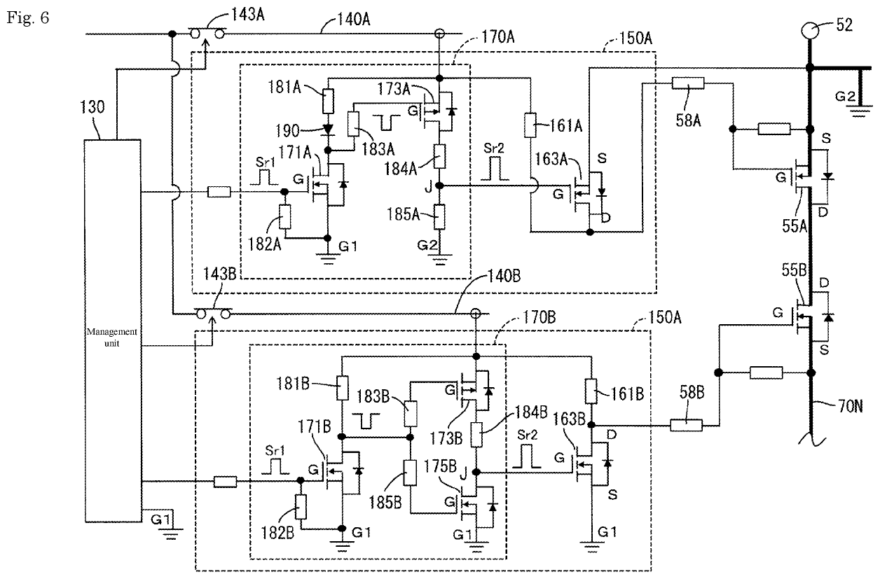

FIG. 6 is a detailed view of the first drive circuit 150A and the second drive circuit 150B. The first drive circuit 150A includes a first pull-up resistor 161A, a first pull-down switch 163A, and a first conversion circuit 170A.

The first pull-down switch 163A is a signal semiconductor switch. The first pull-down switch 163A is an N-channel field effect transistor. The first pull-down switch 163A has a source connected to the second external terminal 52, and a drain connected to the first internal power source line 140A via the first pull-up resistor 161A. A drain of the first pull-down switch 163A is connected to the gate G of the first cutoff switch 55A via a signal line.

The first pull-down switch 163A has the source connected to the second external terminal 52, and has the body ground G2 as a reference potential (operation reference).

When the first pull-down switch 163A is turned off, the gate G of the first cutoff switch 55A is conducted to the first internal power source line 140A which is a high potential portion, and becomes the H level which is a high potential. When the first pull-down switch 163A is turned on, the gate G of the first cutoff switch 55A is conducted to the body ground G2 which is a low potential portion, and becomes the L level which is a low potential.

When the gate G of the first cutoff switch 55A is conducted to the body ground G2, charges can be extracted from the gate G and flow to the body ground G2, so that the responsiveness of the first cutoff switch 55A can be improved. That is, it is possible to improve responsiveness when the first cutoff switch 55A is switched from on to off. By enhancing the responsiveness, an overcurrent can be quickly cut off. In addition, it is possible to suppress damage to the cutoff switch due to a large current flowing in a transient state between on and off of the first cutoff switch 55A.

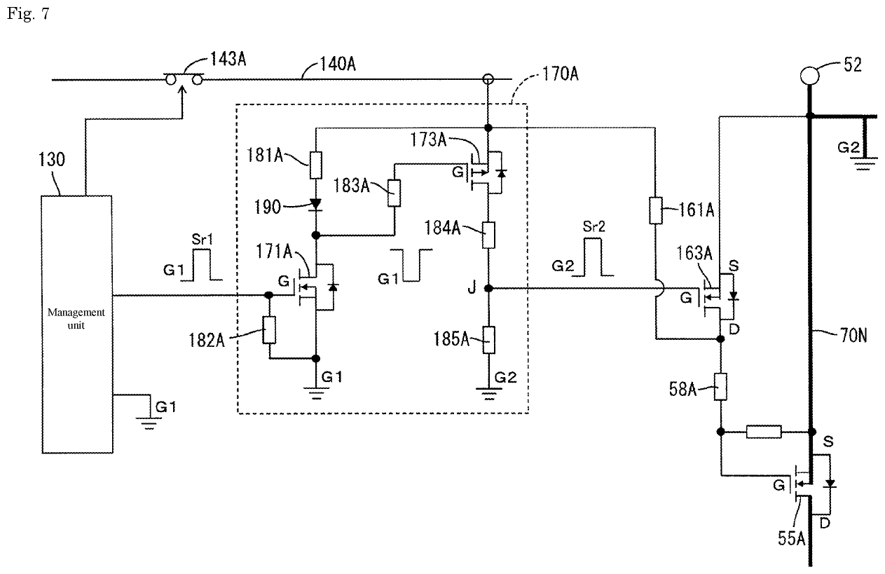

As illustrated in FIG. 7, the first conversion circuit 170A includes a first FET 171A and a second FET 173A. The first FET 171A is for a signal and is an N-channel field effect transistor. The first FET 171A has a source connected to a signal ground G1, and a drain connected to the first internal power source line 140A via a resistor 181A.

A resistor 182A is connected between a gate G and the source of the first FET 171A. The drain of the first FET 171A is connected to a gate G of the second FET 173A via a resistor 183A.

The second FET 173A is for a signal and is a P-channel field effect transistor. The second FET 173A has a source connected to the first internal power source line 140A. The second FET 173A has a drain connected to the body ground G2, that is, the second external terminal 52 via two resistors 184A and 185A.

The two resistors 184A and 185A are connected in series. A connection point J of the two resistors 184A and 185A is connected to a gate G of the first pull-down switch 163A.

When a control signal Sr1 is output from the management unit 130 to the first FET 171A, the signal is inverted in the first FET 171A, and the signal is inverted again in the second FET 173A, so that a control signal Sr2 having the same waveform as the control signal Sr1 can be output from the connection point J. Since the resistor 185A is connected to the body ground G2, the control signal Sr2 is a signal with the body ground G2 as a reference potential.

The first conversion circuit 170A converts the control signal Sr1 output from the management unit 130 from a control signal with the signal ground G1 as a reference potential to the control signal Sr2 with the body ground G2 as a reference potential, and outputs the converted signal to the first pull-down switch 163A. By converting the reference potential of the control signal Sr2 into the body ground G2 (=the potential of the second external terminal 52), the reference potential can be matched with the reference potential (operation reference) of the first pull-down switch 163A.

That is, a reference potential of the management unit 130 is the signal ground G1, the reference potential of the first pull-down switch 163A is the body ground G2, and the reference potentials are different from each other. The first conversion circuit 170A converts the reference potential of the control signal to match the reference potentials.

The first conversion circuit 170A also performs voltage conversion. The control signal Sr1 is converted into a drive voltage of the first pull-down switch 163A in the first conversion circuit 170A, and is output as the control signal Sr2.

As illustrated in FIG. 6, the second drive circuit 150B includes a second pull-up resistor 161B, a second pull-down switch 163B, and a second conversion circuit 170B.

The second pull-down switch 163B is a signal semiconductor switch. The second pull-down switch 163B is an N-channel field effect transistor. The second pull-down switch 163B has a source connected to a signal ground G1, and a drain connected to the second internal power source line 140B via the second pull-up resistor 161B. A drain of the second pull-down switch 163B is connected to the gate G of the second cutoff switch 55B via a signal line.

The second pull-down switch 163B has a source connected to the signal ground G1, and has a signal ground S1 as a reference potential (operation reference).

When the second pull-down switch 163B is turned off, the gate G of the second cutoff switch 55B is electrically conducted to the second internal power source line 140B, and becomes the H level. When the second pull-down switch 163B is turned on, the gate G of the second cutoff switch 55B is electrically conducted to the signal ground G1, and becomes the L level.

The second conversion circuit 170B includes a first FET 171B and a second FET 173B. The first FET 171B is for a signal and is an N-channel field effect transistor. The first FET 171B has a source connected to a signal ground G1, and a drain connected to the second internal power source line 140B via a resistor 181B. A resistor 182B is connected between a gate and the source of the first FET 171B.

The drain of the first FET 171B is connected to a gate of the second FET 173B via a resistor 183B.

The second FET 173B is for a signal and is a P-channel field effect transistor. The second FET 173B has a source connected to the second internal power source line 140B, and a drain connected to a resistor 184B. The resistor 184B and a fourth FET 175B are connected in series. A connection point J between the resistor 184B and the fourth FET 175B is connected to a gate G of the second pull-down switch 163B.

The fourth FET 175B is an N-channel field effect transistor. The fourth FET 175B has a source connected to a signal ground G1, and a drain connected to the resistor 184B. A gate of the fourth FET 175B is connected to the drain of the first FET 171B via a resistor 185B.

When a control signal Sr1 is output from the management unit 130 to the first FET 171B, the signal is inverted in the first FET 171B, and the signal is inverted again in the second FET 173B, so that a control signal Sr2 having the same waveform as the control signal Sr1 can be output from the connection point J.

Similarly to the management unit 130, the second pull-down switch 163 has a potential of the signal ground S1 as the reference potential (operation reference). Therefore, the second conversion circuit 170B does not have a reference potential conversion function.

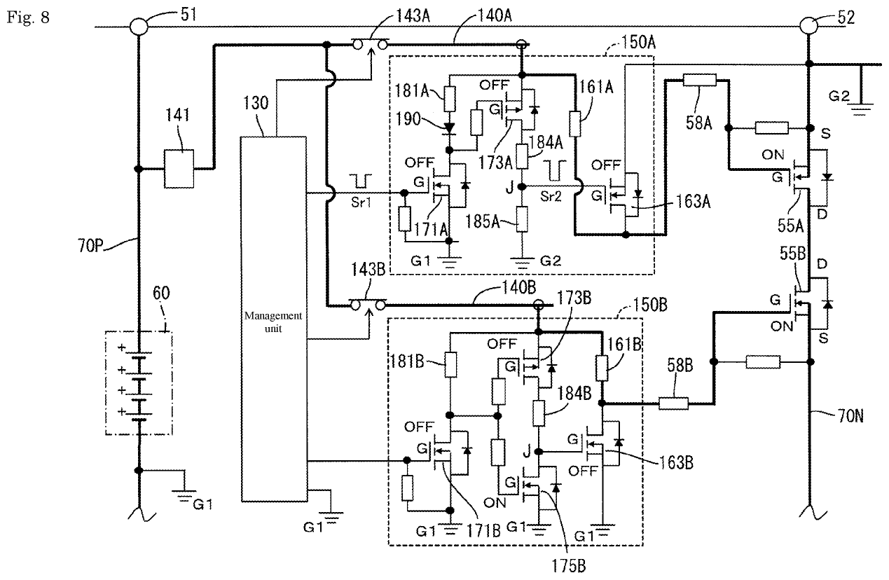

FIG. 8 is an explanatory diagram of a circuit operation of the first drive circuit 150. When the control signal Sr1 at the L level is output from the management unit 130, the first FET 171A and the second FET 173A are turned off, and the control signal Sr2 at the L level is output from the connection point J to the first pull-down switch 163A.

Since the gate G of the first pull-down switch 163A becomes the L level by the power of the control signal Sr2 at the L level, the first pull-down switch 163A is turned off.

When the first pull-down switch 163A is turned off, the gate G of the first cutoff switch 55A is conducted to the first internal power source line 140A via the first pull-up resistor 161A.

When the first cutoff switch 55A is conducted to the first internal power source line 140A, the gate G of the first cutoff switch 55A becomes the H level, and the first cutoff switch 55A is turned on. Similarly, when the control signal Sr1 at the L level is output from the management unit 130 to the second drive circuit 150B, the second cutoff switch 55B is turned on.

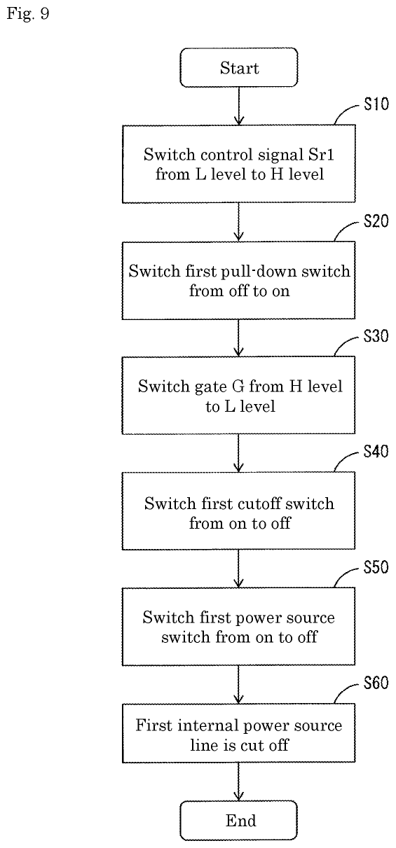

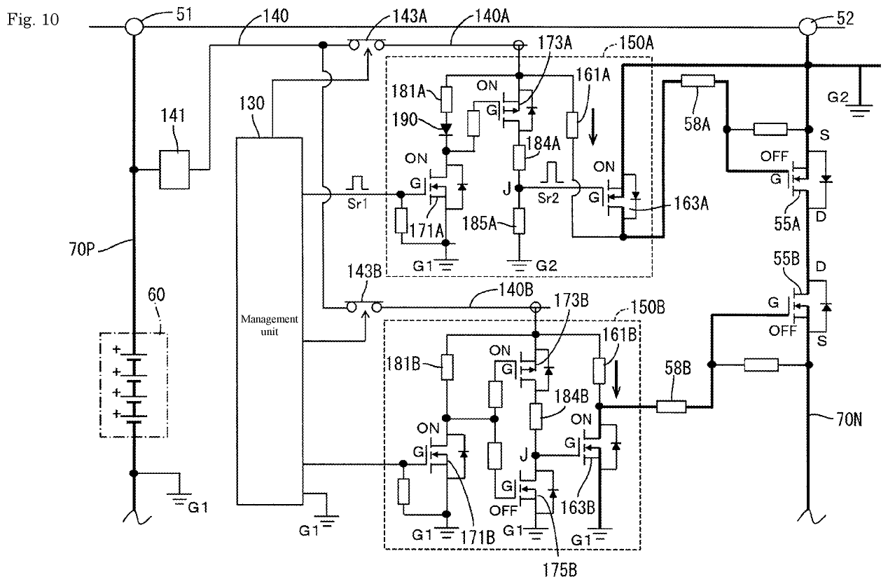

FIG. 9 is a flowchart of an off process for switching the first cutoff switch 55A from on to off. When the management unit 130 switches the control signal Sr1 output to the first drive circuit 150A from the L level to the H level, as illustrated in FIG. 10, the first FET 171A and the second FET 173A are switched from off to on, and the control signal Sr2 at the H level is output from the connection point J to the first pull-up switch 163A (S10).

Since the gate of the first pull-down switch 163A becomes the H level by the power of the control signal Sr2 at the H level, the first pull-down switch 163A is turned on (S20).

When the first pull-down switch 163A is turned on, as illustrated in FIG. 10, the gate G of the first cutoff switch 55A is conducted to the body ground G2 via the first pull-down switch 163A. Due to the conduction to the body ground G2, the gate G of the first cutoff switch 55A is switched from the H level to the L level (S30).

When the gate G is switched from the H level to the L level, the first cutoff switch 55A is switched from on to off (S40).

When the first pull-down switch 163A is turned on, a current flows from the first internal power source line 140A to the first pull-up resistor 161A. When the resistance value of the first pull-up resistor 161A is high, the power consumption by the first pull-up resistor 161A at this time can be sufficiently reduced. However, when the resistance value of the first pull-up resistor 161A is high, the responsiveness of switching the first cutoff switch 55A from off to on decreases, and thus the resistance value of the first pull-up resistor 161A is set to a low value to some extent. Therefore, the power consumption by the first pull-up resistor 161A cannot be sufficiently reduced.

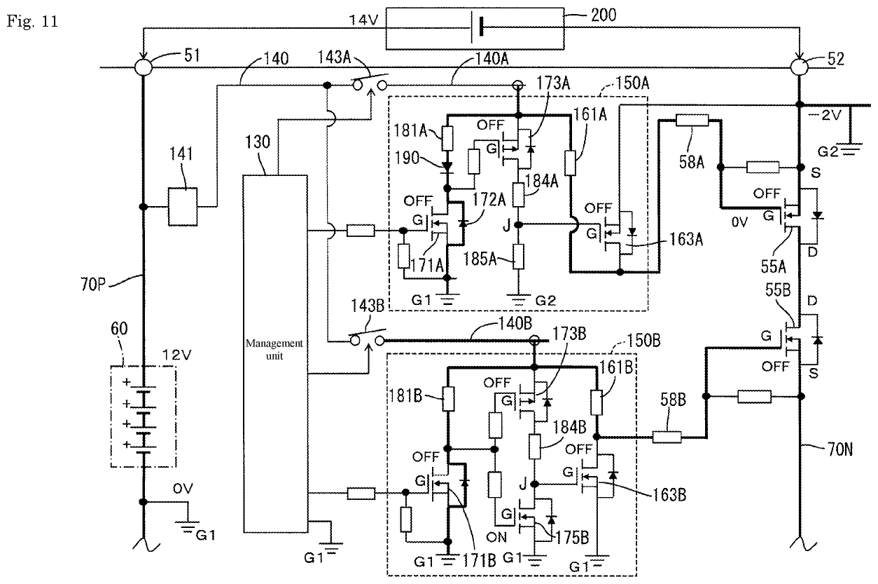

When the first cutoff switch 55A is switched from on to off, the management unit 130 switches the first power source switch 143A from on to off as illustrated in FIG. 11 (S50). When the first power source switch 143A is turned off, the first internal power source line 140A is cut off (S60). By cutting off the first internal power source line 140A, the power consumption by the first pull-up resistor 161A can be suppressed.

In addition, the management unit 130 can switch the second cutoff switch 55B from on to off by switching the control signal Sr1 output to the second drive circuit 150B from the L level to the H level.

The same applies to the case where the second cutoff switch 55B is switched from on to off, and the management unit 130 switches the second power source switch 143B from on to off to cut off the second internal power source line 140B. By cutting off the second internal power source line 140B, the power consumption by the second pull-up resistor 161B can be suppressed.

4. Preventing Malfunction of First Cutoff Switch

When the first power source switch 143A is turned off in order to suppress the power consumption when the first cutoff switch 55A is turned off, the management unit 130 controls the first FET 171A to be turned off together with the first power source switch 143A.

Even when the first FET 171A is controlled to be turned off, the gate G of the first cutoff switch 55A is conducted to the signal ground G1 via the gate resistor 58A, the first pull-up resistor 161A, the resistor 181A, and the parasitic diode 172A of the first FET 171A as illustrated in FIG. 11. On the other hand, the source S of the first cutoff switch 55A is connected to the body ground G2.

Even in a case where a voltage difference occurs between the signal ground G1 and the body ground G2 while the first cutoff switch 55A is turned off, a voltage difference occurs between the gate G and the source S, and the first cutoff switch 55A may erroneously operate from off to on.

In addition, even in a case where a charger 200 is connected to the battery 50 when the first cutoff switch 55A is turned off, a voltage difference occurs between the gate G and the source S, and the first cutoff switch 55A may erroneously operate from off to on. For example, when the power voltage of the charger 200 is 14 V and the total voltage of the assembled battery 60 is 12 V, a voltage difference of about 2 V occurs between the gate G and the source S, and the first cutoff switch 55A may erroneously operate from off to on.

In the first drive circuit 150A, a diode 190 is provided between the drain of the first FET 171A and the resistor 181A. The diode 190 is in the opposite direction to the parasitic diode 172A.

By providing the diode 190, while the first internal power source line 140A is cut off, the gate of the first cutoff switch 55A has high impedance and can be prevented from being conducted to the signal ground G1. Therefore, it is possible to suppress malfunction of the first cutoff switch 55A. The diode 190 is an energization cutoff element that blocks conduction of the gate G of the first cutoff switch 55A to the signal ground G1.

The second cutoff switch 55B has the source S connected to the signal ground G1. Therefore, while the second internal power source line 140B is cut off, the gate G and the source S of the second cutoff switch 55B are both at the potential of the signal ground G1, and no potential difference is generated. Therefore, the diode 190 is not installed in the second drive circuit 150B.

5. Description of Effects

When the first cutoff switch 55A is turned off, the battery 50 can maintain low power consumption by cutting off the first internal power source line 140A and cutting off the current of the first drive circuit 150A. Similarly, when the second cutoff switch 55B is turned off, low power consumption can be maintained by cutting off the second internal power source line 140B and cutting off the current of the second drive circuit 150B.

In addition, since the diode 190 blocks conduction of the gate G of the first cutoff switch 55A to the signal ground G1, it is possible to suppress the malfunction of the first cutoff switch 55A when the first internal power source line 140A is cut off.

### Second Embodiment

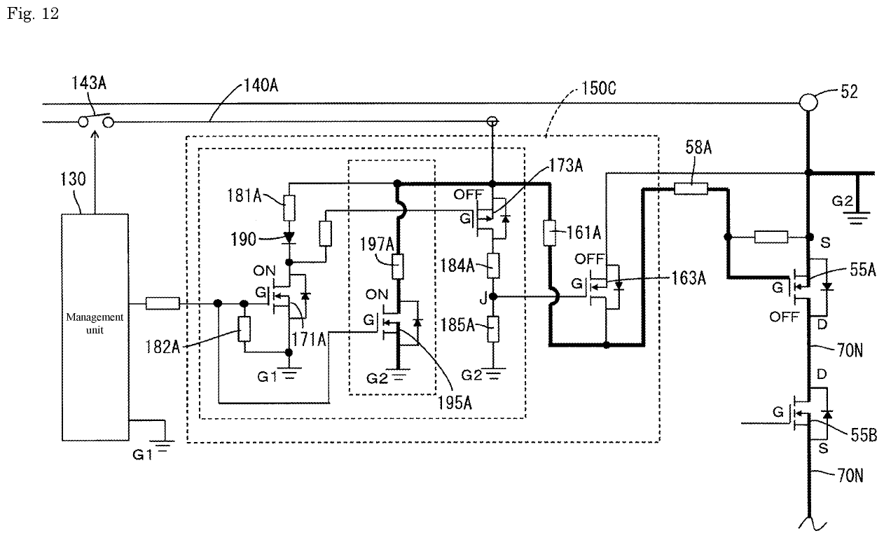

The second embodiment is different from the first embodiment in a configuration of a first drive circuit 150C. As illustrated in FIG. 12, the first drive circuit 150C includes a first pull-up resistor 161A, a first pull-down switch 163A, a first conversion circuit 170A, and a conduction circuit 193A.

The conduction circuit 193A includes a conduction switch 195A and a resistor 197A. The conduction switch 195A is an N-channel field effect transistor. The conduction switch 195A has a source connected to a body ground G2, and a drain connected to the first internal power source line 140A via the resistor 197A. A gate G of the conduction switch 195A is connected to the gate G of the first FET 171A.

While the first internal power source line 140A is cut off, the management unit 130 outputs the H level control signal to the gate G of the conduction switch 195A to turn on the conduction switch 195A.

As illustrated in FIG. 12, when the conduction switch 195A is turned on, the gate of the first cutoff switch 55A is conducted to the body ground G2 via the gate resistor 58A, the first pull-up resistor 161A, and the resistor 197A. When the gate G is conducted to the body ground G2, the gate G and the source S have the same potential, and no voltage difference is generated, so that it is possible to suppress the malfunction of the first cutoff switch 55A.

The management unit 130 turns off the conduction switch 195A while the first cutoff switch 55A is turned on. By turning off the conduction switch 195A, it is possible to suppress power consumption of the conduction circuit 193A while the first cutoff switch 55A is turned on.

### Other Embodiments

The present invention is not limited to the embodiments described above referring to the drawings, and, for example, the following embodiments are also included in the technical scope of the present invention.

(1) In the first and second embodiments, the secondary battery 62 is described as an example of an energy storage device. The energy storage device is not limited to the secondary battery 62, and may be a capacitor. The secondary battery 62 is not limited to a lithium ion secondary battery, and may be another nonaqueous electrolyte secondary battery. In addition, a lead-acid battery or the like can also be used. The energy storage device is not limited to the case where a plurality of energy storage devices are connected in series and parallel, and the energy storage devices may be connected in series or may have a single cell configuration.

(2) In the first and second embodiments, the battery 50 is used for starting the engine. The use of the battery 50 is not limited to a specific use. The battery 50 may be used in various applications such as a mobile object (vehicle, flight vehicle, ship, AGV, etc.) and an industrial application (an energy storage apparatus of an uninterruptible power supply system or a solar power generating system).

(3) In the first and second embodiments, the cutoff switch 55 is disposed on the negative electrode side (low side) of the assembled battery 60, but may be disposed on the positive electrode side (high side) of the assembled battery 60. The cutoff switch 55 is not limited to a field effect transistor. The cutoff switch may be a semiconductor switch other than the field effect transistor.

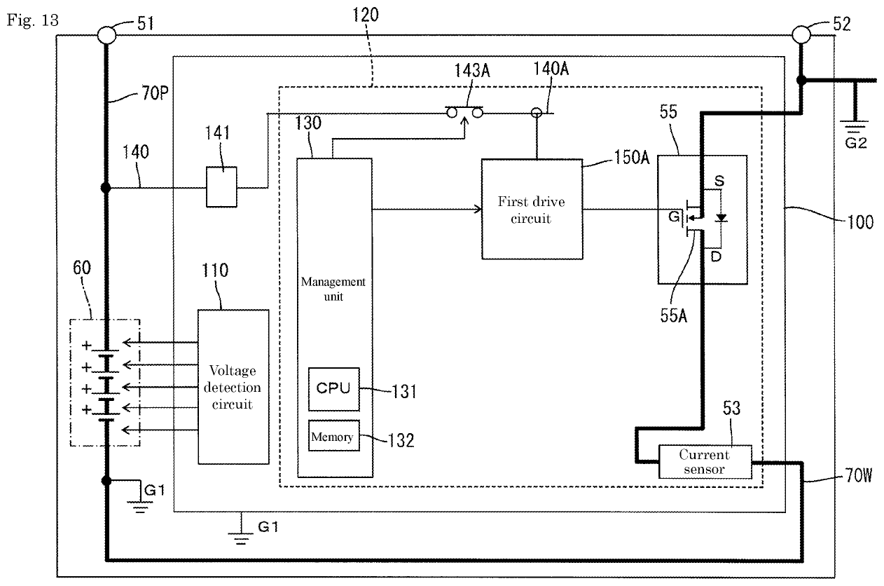

(4) In the first and second embodiments, the cutoff switch 55 includes the first cutoff switch 55A and the second cutoff switch 55B. As illustrated in FIG. 13, the energy storage apparatus may include, as the cutoff switch 55, only the first cutoff switch 55A that restricts charge. Alternatively, the energy storage apparatus may include only the second cutoff switch 55B that restricts discharge.

(5) In the second embodiment, the conduction of the gate G of the first cutoff switch 55A to the signal ground G1 is cut off using the diode 190. The conduction may be cut off by a switch instead of the diode 190.

(6) The means for switching the control terminal of the cutoff switch from a high potential to a low potential is not limited to the example using the pull-up resistor and the pull-down switch. For example, a push-pull circuit may alternatively be used as such means. However, as compared with the push-pull circuit, the circuit using the pull-up resistor and the pull-down switch can be manufactured at a lower cost.

(7) The present technology can be applied to a control program for a protective circuit of an energy storage device. The protective circuit includes a cutoff switch that cuts off a current of the energy storage device, a drive circuit that drives the cutoff switch, and a power source switch provided on a power source line of the drive circuit. A control program for the protective circuit is a program for causing a computer to execute: a process (S30) of switching a control terminal of the cutoff switch from a high potential to a low potential by switching a pull-down switch of the drive circuit from off to on; and a process (S50) of turning off the power source switch after switching the control terminal to the low potential. The present technology can be applied to a recording medium in which a control program for a protective circuit of an energy storage device is recorded. The computer is, for example, the management unit 130. The energy storage device is, for example, the secondary battery 62. The control program can be recorded in a recording medium such as a ROM.

### DESCRIPTION OF REFERENCE SIGNS

10: motorcycle
50: battery (energy storage apparatus)
51, 52: external terminal
55: cutoff switch
55A: first cutoff switch
55B: second cutoff switch
60: assembled battery
62: secondary battery (energy storage device)
120: protective circuit
130: management unit (control unit)
140A, 140B: first internal power source line, second internal power source line
143A, 143B: first power source switch, second power source switch
150: drive circuit
150A, 150B: first drive circuit, second drive circuit
161A, 161B: first pull-up resistor, second pull-up resistor
163A, 163B: first pull-down switch, second pull-down switch
170A, 170B: first conversion circuit, second conversion circuit
190: diode (energization cutoff element)
193A: conduction circuit

1. A protective circuit for an energy storage device, comprising:
a cutoff switch that cuts off a current of the energy storage device;
a drive circuit that drives the cutoff switch;
a power source switch provided on a power source line of the drive circuit; and
a control unit,
wherein the control unit switches a control terminal of the cutoff switch from a high potential to a low potential, and then turns off the power source switch.

2. The protective circuit according to claim 1, wherein
the drive circuit includes a pull-up resistor that connects the control terminal to a high potential portion, and a pull-down switch that connects the control terminal to a low potential portion, and
the control unit switches the control terminal from a high potential to a low potential by switching the pull-down switch from off to on.

3. An energy storage apparatus comprising:
the energy storage device; and
the protective circuit according to claim 1,
wherein the drive circuit uses the energy storage device as a power source.

4. The energy storage apparatus according to claim 3, further comprising:
a first external terminal connected to a positive electrode of the energy storage device; and
a second external terminal connected to a negative electrode of the energy storage device,
wherein the cutoff switch includes at least a first cutoff switch that cuts off charge to the energy storage device,
the drive circuit includes at least a first drive circuit that is connected to a first power source line including a first power source switch and drives the first cutoff switch,
the first cutoff switch comprises an N-channel FET having a source connected to the second external terminal and a drain connected to a negative electrode of the energy storage device,
the first drive circuit includes:
a first pull-up resistor that connects a gate of the first cutoff switch to the first power source line;
a first pull-down switch that connects the gate of the first cutoff switch to the second external terminal; and
a first conversion circuit that converts a reference potential of a control signal output from the control unit from a signal ground of the protective circuit to a potential of the second external terminal and outputs the converted signal to the first pull-down switch, and
the first conversion circuit includes a conduction cutoff element that cuts off conduction of the gate of the first cutoff switch to the signal ground of the protective circuit when the first power source switch is turned off.

5. The energy storage apparatus according to claim 4, wherein
the first conversion circuit includes:
an N-channel first FET having a source connected to the signal ground of the protective circuit, a drain connected to the first power source line via a resistor, and a gate connected to the control unit; and
a P-channel second FET having a source connected to the first power source line, a drain connected to the second external terminal via a resistor, and a gate connected to a drain of the first FET, and
the conduction cutoff element comprises a reverse diode in a direction opposite to a parasitic diode of the first PET.

6. The energy storage apparatus according to claim 4, wherein the first drive circuit includes a conduction circuit that conducts the gate of the first cutoff switch to the second external terminal.

7. A control method for a protective circuit of an energy storage device, wherein
the protective circuit includes:
a cutoff switch that cuts off a current of the energy storage device;
a drive circuit that drives the cutoff switch; and
a power source switch provided on a power source line of the drive circuit,
the control method comprising:
switching a control terminal of the cutoff switch from a high potential to a low potential; and
turning off the power source switch after switching the control terminal to a low potential.
